(19) United States
(12) Patent Application Publication
(10) Pub. No.: US 2016/0257554 A1
(43) Pub. Date: Sep. 8, 2016

(54) BEVERAGE DISPENSER WITH ENHANCED FUNCTIONALITY

(71) Applicant: Kuvee, Inc., Boston, MA (US)

(72) Inventors: Vijay Girdhar Manwani, Lexington, MA (US); Geoffrey Blake Lansberry, Andover, MA (US); Michael Stephen Tomovich, Boston, MA (US); David Dolloff Chesley, Duxbury, MA (US); Benjamin Einstein, Somerville, MA (US)

(21) Appl. No.: 15/061,294

(22) Filed: Mar. 4, 2016

Related U.S. Application Data
(60) Provisional application No. 62/128,341, filed on Mar. 4, 2015.

(51) Int. Cl. B67D 3/00

(52) U.S. Cl. CPC B67D 3/0077; B67D 3/0067

(57) ABSTRACT

A beverage dispenser includes a number of features providing enhanced functionality for a user, e.g., functionality beyond what might be found in traditional beverage dispensers. By way of example, an improved beverage dispenser may read data relating to contents, display information and graphics about the contents on a display panel, control and monitor dispensed fluids and so forth. A beverage dispenser instrumented in this manner may also be connected through a network to remote resources in order to augment local information and provide a rich, interactive user experience.

### CROSS-REFERENCE TO RELATED APPLICATIONS

This application claims the benefit of U.S. Prov. App. No. 62/128,341 filed on Mar. 4, 2015, the entire content of which is hereby incorporated by reference.

This application is related to U.S. patent application Ser. No. 14/675,095 filed on Mar. 31, 2015, which claims the benefit of U.S. Prov. App. No. 61/974,086 filed on Apr. 2, 2014 and U.S. Prov. App. No. 62/128,341 filed on Mar. 4, 2015, where the entire content of each of the foregoing applications is hereby incorporated by reference.

### TECHNICAL FIELD

The disclosure relates to a beverage dispenser with enhanced functionality.

### BACKGROUND

There remains a need for a beverage dispenser with enhanced functionality.

### SUMMARY

A beverage dispenser includes a number of features providing enhanced functionality for a user, e.g., functionality beyond what might be found in traditional beverage dispensers. By way of example, an improved beverage dispenser may read data relating to contents, display information and graphics about the contents on a display panel, control and monitor dispensed fluids and so forth. A beverage dispenser instrumented in this manner may also be connected through a network to remote resources in order to augment local information and provide a rich, interactive user experience.

In an aspect, a system for beverage dispensing includes a dispenser shaped and sized as a wine bottle, the dispenser including a spout and a receptacle, and the receptacle configured to removably and replaceably retain a beverage cartridge in an active engagement providing a fluid path to pour a fluid from the beverage cartridge through the spout. The system may also include a cartridge interface disposed within the dispenser and configured to receive and mechanically retain the beverage cartridge in active engagement with the dispenser, the cartridge interface further including a data reader configured to read information from the beverage cartridge about a beverage in the beverage cartridge. The system may further include a user interface including a display disposed on an exterior of the dispenser, and a processor within the dispenser, the processor configured to receive information about the beverage from the data reader and to present corresponding information in the display.

Implementations may include one or more of the following features. The system may further include a network interface coupled to the dispenser, the network interface configured to couple the processor in a communicating relationship with a remote resource. The processor may be configured to retrieve beverage information for the beverage from the remote resource and present the beverage information on the display. The beverage information may include interactive content. The system may further include a fluid sensing system including one or more sensors providing signals to the processor and code executable by the processor to detect an amount of fluid dispensed from the beverage cartridge. The processor may be configured to transmit beverage dispensing information to the remote resource based on the amount of fluid dispensed. The beverage dispensing information may include an estimate of fluid remaining in the beverage cartridge. The processor may be configured to store the beverage dispensing information on a memory of the beverage cartridge. The network interface may include a short range radio frequency communications interface. The processor may be configured to present an interactive interface in the display for purchasing beverages through the remote resource. The remote resource may be configured to monitor consumption behavior based on distribution of beverages from the dispenser and to present purchase recommendations on the display based on inferred beverage preferences. The data reader may include a radio frequency identification tag reader positioned to read a corresponding radio frequency identification tag positioned on the beverage cartridge. The system may further include one or more environmental sensors, where the processor is configured to receive environmental data from the one or more environmental sensors and estimate a state of contents of the beverage cartridge based on the environmental data. The one or more environmental sensors may include at least one temperature sensor. The system may further include a manual valve control disposed on an exterior of the dispenser and configured to control pouring from the beverage cartridge based on a manual user input. The system may further include a memory within the dispenser, the memory storing beverage information for a number of beverages in a number of beverage cartridges, the beverage information including interactive content relating to the number of beverages for presentation on the display of the dispenser. The system may further include a memory within the dispenser, the memory storing a history of beverage distribution from the dispenser for a number of beverage cartridges. The processor may be configured to determine a current user of the dispenser during a pour. The current user may be determined based on a manual input in the user interface or a pattern of motion detected during a pour from the dispenser. A personalized purchase recommendation may be generated for the current user and presented on the display.

In another aspect, a system for beverage dispensing includes a dispenser shaped for attachment to a beverage container, a mechanical interface for coupling the dispenser to the beverage container, a data reader configured to capture data from the beverage container attached to the dispenser, a user interface including a display disposed on an exterior of the dispenser, and a processor within the dispenser, the processor configured to receiving information about the beverage from the data reader and to present corresponding information in the display.

Implementations may include one or more of the following features. The system may further include a fluid monitoring system including one or more sensors disposed within the dispenser and configured by the processor to monitor fluid information including at least one of fluid exiting the beverage container and fluid within the beverage container. The system may further include a network interface, the network interface configured to couple the processor in a communicating relationship with a remote resource for at least one of monitoring fluid consumption from the beverage container, recommending additional beverages for purchase, and performing a transaction to purchase a new beverage.

In yet another aspect, a system for beverage dispensing includes a dispenser including a spout and a receptacle, the receptacle configured to removably and replaceably retain a beverage cartridge in an active engagement providing a fluid path to pour a fluid from the beverage cartridge through the spout. The system may also include a cartridge interface disposed within the dispenser and configured to receive and mechanically retain the beverage cartridge in the active engagement with the dispenser, the cartridge interface further including a data reader configured to read information from the beverage cartridge about a beverage in the beverage cartridge. The system may further include a processor within the dispenser configured to receive information about the beverage from the data reader, and a network interface configured to couple the processor in a communicating relationship with a remote resource for at least one of monitoring fluid consumption from the beverage cartridge, recommending an additional beverage for purchase, and performing a transaction to purchase a new beverage.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein.

FIG. 1 shows a networked environment for a beverage dispenser with enhanced functionality.

FIG. 2 shows a system for beverage dispensing.

FIG. 3 shows a cartridge.

FIG. 4 shows a cartridge being inserted into a dispenser.

FIG. 5 shows a display on a dispenser.

FIG. 6 shows a beverage system in use.

FIG. 7 shows a coordinate system for measuring dispenser acceleration.

FIG. 8 shows a first graph representing a pouring profile for a negative 50 degree tilt angle of a container and a second graph representing flow rate versus an amount poured from the container.

FIG. 9 shows a graph of a three-dimensional surface used to predict flow rate at a given angle.

FIG. 10 shows a graph representing the effect of temperature on flow rate.

FIG. 11 shows a first graph representing an amount of liquid poured over time and a second graph representing a tilt angle over time.

### DETAILED DESCRIPTION

The embodiments will now be described more fully hereinafter with reference to the accompanying figures, in which preferred embodiments are shown. The foregoing may, however, be embodied in many different forms and should not be construed as limited to the illustrated embodiments set forth herein. Rather, these illustrated embodiments are provided so that this disclosure will convey the scope to those skilled in the art.

All documents mentioned herein are incorporated by reference in their entirety. References to items in the singular should be understood to include items in the plural, and vice versa, unless explicitly stated otherwise or clear from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms unless specifically stated to the contrary.

In general, the devices, systems, and methods described herein may be used in conjunction with, may supplement, or may be supplemented by any of the devices, systems, and methods described in U.S. patent application Ser. No. 14/675,095, the entire content of which is hereby incorporated by reference. The devices, systems, and methods described herein provide a beverage dispenser that may enhance the ability of a consumer to appreciate the story of the beverage, which can be richly retold through any suitable multimedia using the display capabilities of a ‘smart’ system. Thus, implementations can bring a multi-page story to life where the user can swipe a ‘smart’ label to read about the story of (in the case of the beverage being a wine) the vineyards, the winemaker, the wine region, and so forth. In this case, the smart beverage dispenser can download this multi-page story through a data network. Additional benefits may include guidance on a proper serving (e.g., proper temperature and suitable breathing time), accurate serving sizes through free or measured pours, shopping assistance (e.g., through purchasing from a user interface), and targeted information such as promotions, offers, and recommendations based on user profile and drinking profile. For a beverage producer, benefits may include access to user demographics and drinking data, as well as the ability to communicate a rich story for the beverage beyond the label.

It will be understood that while embodiments described herein may emphasize the use of wine in the various dispensers or cartridges described herein, embodiments may also or instead be adapted for use with other fluids such as alcohol, milk, juice (e.g., fruit or vegetable), water, and so forth, as well as other liquids that are not intended for human consumption. Thus, any description referencing a beverage (e.g., wine) is intended to include other liquid contents unless explicitly stated or otherwise clear from the context.

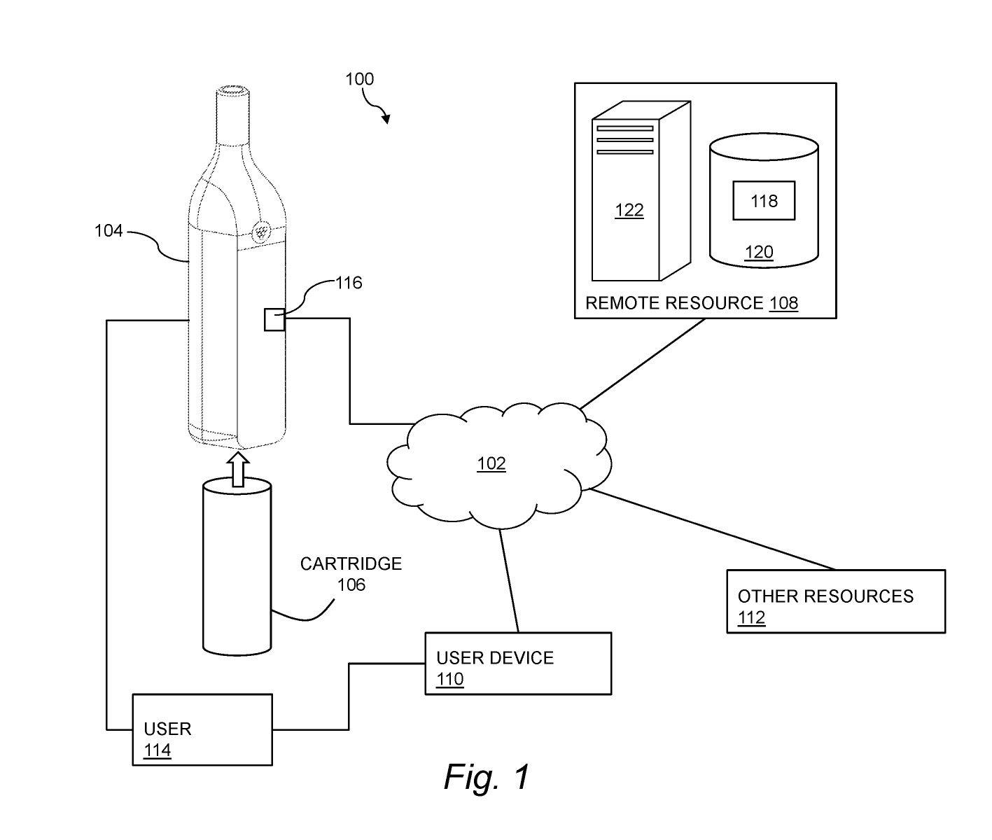

FIG. 1 shows a networked environment for a beverage dispenser with enhanced functionality. The networked environment 100 may include a data network 102 interconnecting a plurality of participating devices, systems, and resources in a communicating relationship. The participants in the environment 100 may, for example, include a dispenser 104, a cartridge 106, a remote resource 108, a user device 110, and one or more other resources 112.

The data network 102 may be any network(s) or internetwork(s) suitable for communicating data among participants in the environment 100. This may include public networks such as the Internet, private networks, telecommunications networks such as the Public Switched Telephone Network or cellular networks using third generation (e.g., 3G or IMT-2000), fourth generation (e.g., LTE (E-UTRA) or WiMax-Advanced (IEEE 802.16m)) and/or other technologies, as well as any of a variety of corporate area or local area networks and other switches, routers, hubs, gateways, and the like that might be used to carry data among participants in the environment 100. The data network 102 may include wired or wireless networks, or any combination thereof. The data network 102 may also or instead include short range data communications such as Bluetooth or infrared communications, which may be used to couple into a local area network or the like that is in turn coupled to another network such as the Internet. One skilled in the art will also recognize that the participants shown the environment 100 need not be connected by a data network 102, and thus can be configured to work in conjunction with other participants independent of the data network 102.

The dispenser 104 may be configured for cooperation and engagement with the cartridge 106 thereby providing a storage and dispensing unit for liquid contents such wine or any other beverage or the like. The dispenser 104 may include a number of features providing functionality for a user 114, e.g., functionality beyond what might be found in traditional beverage dispensers. For example, the dispenser 104 may sense contents (e.g., volume, type, brand, etc.) and data related thereto (e.g., using a data reader or the like to read information from the cartridge 106), display information and graphics on a graphical user interface or the like, control and monitor dispensing of contents and so forth. To perform these various functions, the dispenser 104 may be a connected device, e.g., where the dispenser 104 includes a network interface 116 for communications with other entities within the environment 100, e.g., through the data network 102 or other short range communications protocols. The dispenser 104 may also include one or more sensors, a processor, and a memory for performing various functions such as those described herein.

The network interface 116 may include any combination of hardware and software suitable for coupling the dispenser 104 in a communicating relationship with other entities within the environment 100. By way of example and not limitation, this may include electronics for a wired or wireless Ethernet connection operating according to the IEEE 802.11 standard (or any variation thereof), or any other short or long range wireless networking components or the like. This may also or instead include hardware for short range data communications such as Bluetooth, infrared transceivers, near field communications readers, radio frequency identification tags and readers, and so forth, which may be used to couple into a local area network or the like that is in turn coupled to the data network 102. The network interface 116 may also or instead include hardware/software for a WiMax connection or a cellular network connection (using, e.g., CDMA, GSM, LTE, or any other suitable protocol or combination of protocols). One or more of the entities within the environment 100 may similarly include a network interface 116 such as any of those described above for short range communication with the dispenser 104 or networked communications through the data network 102.

The cartridge 106 may include liquid contents such as a beverage contained therein. In one aspect, the cartridge 106 may be configured for housing oxygen-sensitive beverages such as wine, beer, milk, fruit juices. In general, the dispenser 104 and cartridge 106 may be configured to reduce and mitigate spoilage by preventing exposure of the beverage to atmospheric oxygen, thus facilitating consumption of the beverage gradually over time. The cartridge may be configured to store the beverage, and be further configured to be removably and replaceably engaged with the dispenser 104 for dispensing of the beverage. The cartridge 106 may be removably and replaceably disposed inside the dispenser 104 where the cartridge placed into a state for fluid dispensing. The cartridge 106 may communicate with the dispenser 104 via short range data communications. In another aspect, the dispenser 104 may include one or more data readers configured to read information from the cartridge 106 about the contents of the cartridge 106, and the cartridge 106 may include a corresponding radio frequency identification tag or any other suitable memory-bearing circuitry. In another aspect, information about the beverage may be mechanically coded into the cartridge 106 for detection by the dispenser 104 when the cartridge 106 is inserted into the dispenser 104.

In an implementation, the dispenser 104 may accept and engage the cartridge 106, recognize the cartridge 106 (e.g., using a data reader or the like), and display information relating to the contents of the cartridge 106 on a display on the dispenser 104. One or more of the dispenser 104 and the cartridge 106 may include electrical and mechanical elements to provide useful features, including without limitation, metering how much fluid is dispensed, controlling how much fluid is being poured out of the cartridge 106, estimating or tracking the amount of fluid remaining in the cartridge 106, and so forth.

The remote resource 108 may store data 118 such as information regarding the contents of the cartridge 106/dispenser 104, e.g., beverage information. For example, the data 118 may include taste information that relates different beverages to one another according to taste. This information may be usefully employed to generate new recommendations to the user 114 based on a current beverage in the cartridge 106. The data 118 may also or instead include detailed information about various beverages. With this data, the environment 100 may respond to a connection of a cartridge 106 to a dispenser 104 by identifying the beverage contained in the cartridge 106, e.g., using any of the sensors or detectors contemplated herein, and then retrieving relevant information from the remote resource 108. This may, for example, include information about a wine in the cartridge 106 such as types of grapes, geographic region, vineyard information, weather or other seasonal data for the year(s) of the wine in the cartridge 106, and so forth. This permits a presentation of a rich beverage story and history through the display 116 of the dispenser 104, based on the beverage detected in the cartridge 106. As another example, the data 118 may include consumption history for the user 114, inventory information, purchase recommendations, or any other information that might be relevant to the user 114 and suitable for presentation in the display 116.

The data 118 may be transmitted to the dispenser 104 (e.g., after being requested by the dispenser 104 or where the remote resource 108 is otherwise triggered for transmitting the data 118) or the data 118 may be otherwise retrieved by the dispenser 104 through the data network 102. In an aspect, the data 118 is transmitted to the dispenser 104 in periodic updates that can be prescheduled or manually requested by a user 114. The data 118 may be stored in a database 120 or other computer-accessible data repository disposed on, or in communication with, one of the remote resources 108. The data may also or instead be communicated among or stored on one or more of the dispenser 104, the cartridge 106, the user device 110, another remote resource 108, or the other resource 112.

The remote resource 108 may include a beverage/dispenser management facility that controls, manages, monitors, or supports a plurality of dispensers 104 or cartridges 106. The remote resource 108 may also or instead include a backend coupled to other remote resources for managing and augmenting operation of the dispenser 104. This may, for example, include transaction engines for purchasing beverages, payment processing platforms, beverage databases, recommendation engines for recommending additional beverages of potential interest, social networking platforms, and so forth. As such, the remote resource 108 may include or be in communication with one or more servers 122 or the like for providing additional functionality. The remote resource 108 may include one or more of an online store, a website, a restaurant or place of business, an application, and so forth.

The user device 110 may include any devices within the environment 100 operated by users to manage, monitor, communicate with, or otherwise interact with other participants in the environment 100. This may include tablets, smart phones, smart watches, desktop computers, laptop computers, network computers, personal digital assistants (PDAs), or any other computing device (mobile or otherwise) that can participate in the environment 100 as contemplated herein. In one aspect, the user device 110 is integral with dispenser 104. The user device 110 may also or instead include a smart phone or other device locally coupled to the dispenser 104.

The other resources 112 may include any other platforms, resources, systems, devices, and the like that may be useful in the environment 100 as described herein. For example, the other resources 112 may include a social networking platform where users 114 of the devices 104 or cartridges 106 can be connected, e.g., based on comment tastes or consumption patterns in implementations including beverage dispensing systems.

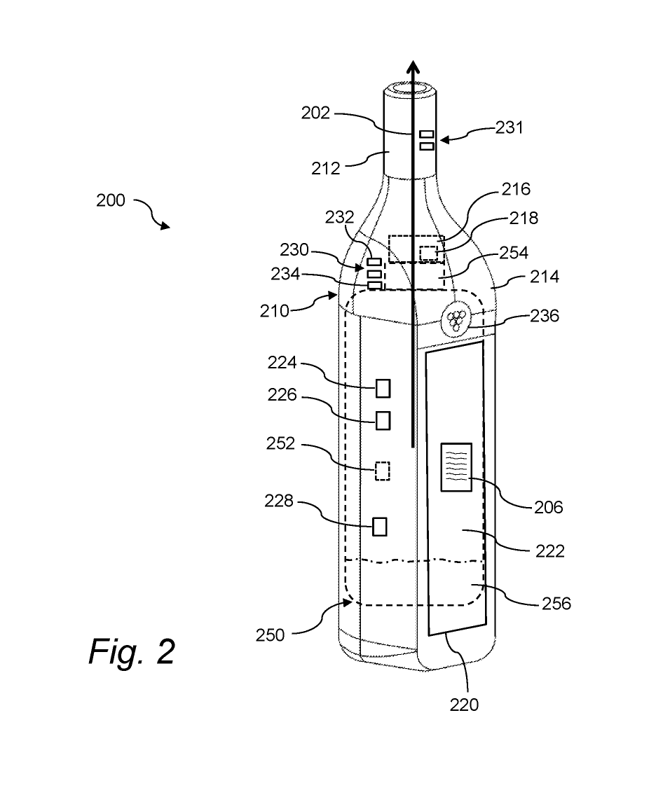

FIG. 2 shows a system for beverage dispensing. The system 200 may include a dispenser 210 and a beverage cartridge 250. In general, the dispenser 210 may be a device that removably and replaceably receives the beverage cartridge 250 and cooperates with the beverage cartridge 250 for use in beverage dispensing. In one aspect, the beverage cartridge 250 is inserted into the dispenser 210 for dispensing wine or the like. The beverage dispenser may include a number of features providing enhanced functionality for a user, e.g., functionality beyond what might be found in traditional beverage dispensers.

The dispenser 210 may be structurally configured to removably and replaceably receive the beverage cartridge 250. In an aspect, the beverage cartridge 250 is inserted into the dispenser 210 through its bottom end. In another aspect, the dispenser 210 may include a door, hatch, compartment, or the like for receiving the beverage cartridge 250. The dispenser 210 may also or instead include a hinged or clamshell design for receiving the beverage cartridge 250 therein.

In one aspect, the beverage cartridge 250 is inserted into the dispenser 210 for dispensing wine or the like. The dispenser 210 may be shaped and sized as a wine bottle, and can also be fashioned to provide a similar weight and handling properties to mimic the feel and user experience of a conventional wine bottle. For example, the dispenser 210 may be shaped and sized to substantially reproduce a 750 milliliter wine bottle in form, feel, and/or weight. Additionally, a spout 212 included on the dispenser 210 may be structurally configured to provide a natural pour for liquid contents from the beverage cartridge 250 so that the dispenser 210 and beverage cartridge 250, in combination, mimic a pouring behavior of a standard wine bottle. The dispenser 210 may instead be shaped and sized to resemble, e.g., a beer bottle, a water bottle, a jug, a thermos, a sports-drink bottle, a milk bottle, a flask, and so forth. Alternatively, the dispenser 210 may include other shapes useful for holding fluids including without limitation a can shape, a cone shape, a carton shape, a spherical or ellipsoid shape, a decanter shape, a pitcher shape, and so forth. The dispenser 210 may also or instead include a fanciful shape, such as resembling a fruit, a vegetable, an animal, a character, a person, an object, and the like.

The beverage cartridge 250 may generally include a container (e.g., a rigid or flexible container) for housing a fluid, e.g., a beverage. In an aspect, the beverage cartridge 250 includes a variable-volume vessel that shrinks or expands according to an amount of fluid contained therein.

The dispenser 210 may include a spout 212 and a receptacle 214. The spout 212 may be configured to pour the liquid contents from within the dispenser 210 (e.g., from the beverage cartridge 250) to an external environment (e.g., a container such as a wine glass).

The receptacle 214 may be structurally configured to removably and replaceably retain the beverage cartridge 250 in an engagement (e.g., an active engagement) providing a fluid path 202 to pour a fluid from the beverage cartridge 250 through the spout 212. The active engagement may be facilitated by a mechanical interface as described herein.

In general, the mechanical interface may be used for coupling the dispenser 210 to the beverage container 250 in the system 200 for beverage dispensing. For example, in an aspect, a cartridge interface 216 is disposed within the dispenser 210. The cartridge interface 216 may be disposed within an interior portion of the dispenser 210, e.g., in a portion of the receptacle 214 that is substantially adjacent to the spout 212. The cartridge interface 216 may be configured to receive and mechanically retain the beverage cartridge 250 in active engagement with the dispenser 210. The cartridge interface 216 may engage with a dispenser interface 254 disposed on the beverage cartridge 250. In this manner, the cartridge interface 216 and the dispenser interface 254 may include cooperating portions or elements facilitating the mechanical engagement thereof, such as cooperating threaded portions, cooperating male and female engagement portions, one or more of snaps, clips, gibs, hooks, mechanical keys, pins, sliders, and so forth.

In one aspect, when the beverage container 250 is inserted into the dispenser 210, a mechanism on the cartridge interface 216 mechanically holds the beverage container 250 in place in such a manner that the beverage container 250 does not fall out accidentally during pouring and other handling of the system 200. The mechanism may also or instead ensure a proper seal between the beverage container 250 and dispenser 210 such that no liquid leaks beyond the intended fluid path 202 during dispensing and no air infiltrates an interior of the beverage container 250. It will be understood that the functions of preventing air infiltration, maintaining the fluid path 202, and mechanically retaining the beverage container 250 in the dispenser 210, may be performed collectively by a single mechanism or by several different mechanisms operating independently or collectively.

A guillotine design may be employed to hold the beverage container 250 in place. In this configuration, a ring, collar, clasp, or similar may hold the beverage container 250 in place until the user dispenses the beverage container 250 from the dispenser 210. Engagement and disengagement of the guillotine mechanism may be initiated through a user action via the user interface 220 of the dispenser 210 or by the user manually pressing a button or the like on the dispenser 210—e.g., a button that releases the mechanism and disengages the beverage container 250. This guillotine mechanism may be included on one or more of the dispenser 210 and the beverage container 250.

The system may include a data reader 218 configured to capture data from the beverage container 250 attached to the dispenser 210. The data reader 218 may be configured to read information from the beverage cartridge 250, e.g., information about a beverage 256 included in the beverage cartridge 250. The data reader 218 may include a radio frequency identification (RFID) tag reader positioned to read a corresponding RFID tag positioned on the beverage cartridge 250. The data reader 218 may be mounted in close proximity to the top of the inserted beverage cartridge 250, although other locations may also or instead be used. In one aspect, the cartridge interface 216 includes the data reader 218.

The dispenser 210 (e.g., using the data reader 218 or otherwise) may also or instead use other techniques to wirelessly deliver identifying information to the dispenser 210 (or to other components in the system 200). For example, the dispenser 210 may include a sensor, such as an infra-red (IR) beam breaking circuit or the like, that detects when a beverage cartridge 250 has been inserted into the dispenser 210 so that the dispenser 210 knows to start scanning for information such as by looking for an RFID tag via a data reader 218 having an RFID receiver. RFID tags can conveniently alleviate any need for a separate power supply on the beverage cartridge 250, but other techniques may also or instead be used for short range wireless communications including without limitation Bluetooth, WiFi (or any other species of 802.11 communications), Near Field Communications (NFC), and so forth. A contact solution may also or instead be employed, such as a chip with identifying information and/or processes (e.g., similar to those in printer cartridges) that identifies a beverage cartridge 250 and provides supplemental information about contents when it is electrically coupled through a plug, contacts, or the like to the dispenser 210. In one aspect, the RFID tag or identifying chip on the beverage cartridge 250 may include a memory such as a non-volatile memory that can store identifying information such as SKU, brand, or varietal or historical information such as a temperature history (or other history of environmental conditions) or an amount of beverage remaining in the beverage cartridge 250. Such information can be downloaded to the dispenser 210 when coupled to the beverage cartridge 250, and the information can be displayed by the dispenser 210 or otherwise used to manage pouring, display information, or otherwise control operation of the dispenser 210. It will be appreciated that, while a memory in the cartridge 250 may usefully store historical information, such information about the cartridge 250 or the contents thereof may also or instead be stored in the dispenser 210 or at a remote resource accessible by the dispenser 210 through a network as generally described above.

While a variety of suitable wireless techniques for transmitting information are available, other techniques may also or instead be employed (e.g., using the data reader 218 or otherwise). In one aspect, a bar code, quick response (QR) code, printed alphanumeric text or the like may be placed on an exterior of the beverage cartridge 250 in a location where it can be scanned by the dispenser 210 (e.g., the data reader 218) when the beverage cartridge 250 is inserted therein. Thus, the data reader 218 may include a scanner, bar code scanner, RFID tag reader, QR code reader, optical character recognition (OCR) scanner, or any other suitable scanner or combination of scanners useful for machine-based retrieval of information from the cartridge 250. In another aspect, a number of electrical contacts in a plug, cradle, or the like may be provided so that the dispenser 210 can electrically couple to and communicate with the beverage cartridge 250. In this latter implementation, power may also be provided from the dispenser 210 to beverage cartridge 250 via one or more power contacts. In another aspect, the beverage cartridge 250 may be mechanically encoded or keyed so that the dispenser 210 can determine contents of the beverage cartridge 250 based on a mechanical engagement with the dispenser 210 (e.g., via the data reader 218). Any technique for encoding information in this manner may be used such as a series of bumps, ridges, holes, slots, or other mechanical features, and combinations of the foregoing.

The system 200 may include a user interface 220. The user interface 220 may include a display 222 disposed on an exterior of the dispenser 210. The user interface 220 may include a graphical user interface, a text or command line interface, a voice-controlled interface, and/or a gesture-based interface. In general, the user interface 220 may create a suitable display 222 on the dispenser 210 for user interaction. In implementations, the user interface 220 includes an environment facilitating researching and purchasing beverages. The user interface 220 may also or instead control operation of the dispenser 210, as well as provide access to and communication with other resources.

In another aspect, the user interface 220 is provided on a user device such as a laptop, tablet, or smart phone in addition to or in lieu of being disposed on the dispenser 210. The user interface 220 may be maintained by a locally executing application on the dispenser 210 or on a user device that receives data from another component in the system 200. In other embodiments, the user interface 220 may be remotely served and presented on the dispenser 210 or user device, such as where a remote resource includes a web server that provides information through one or more web pages or the like that can be displayed within a web browser or similar client executing on the dispenser 210 or user device. In one aspect, the user interface 220 may include a voice controlled interface that receives spoken commands from a user and/or provides spoken feedback to the user. The user interface 220 may also or instead work in conjunction with sensors disposed on the dispenser 210, e.g., motion sensors, infrared sensors, laser sensors, acoustic sensors, optical sensors, accelerometers and so forth that can receive user input or otherwise infer user intent from user interactions, gestures, and the like.

The display 222 on the dispenser 210 may be disposed in a location typically occupied by a wine label. The display 222 may include a touch screen or the like. Included within the display 222, or in addition to or in lieu of the display 222, the dispenser 210 may include a content delivery platform expressed through a liquid crystal display (LCD), a light-emitting diode (LED) display, an organic light-emitting diode (OLED) display, or other display, which can receive updates through any suitable communications interface and processing circuitry. Alternatively, a server or the like may provide back end services to the dispenser 210.

The system 200 may include a processor 224 and a memory 226, e.g., within the dispenser 210 as shown in the figure. The processor 224 may be configured to receive information about the beverage 256 from the data reader 218 and to present corresponding information in the display 222, e.g., beverage information 206 as shown in the figure.

The processor 224 may be configured to process instructions for execution by the dispenser 210 or components in communication with the dispenser 210. The processor 224 may include a single-threaded processor or a multi-threaded processor. The processor 224 may be capable of processing instructions stored in the memory 226. The processor 224 may be disposed on a circuit board and be configured to work in conjunction with the memory 226 to provide the user interface 220, and to otherwise receive and transmit data and control operation of the dispenser 210. Thus, the functionality of the dispenser 210 described herein can be realized using the processor 224 to execute one or more sequences of instructions contained in the memory 226 to perform predetermined tasks. The processor 224 may run on a Linux/Android/iOS platform or any other suitable hardware, firmware, or operating system (alternatively an operating system may be omitted, e.g., where software is written to operate directly on the hardware, i.e., without an operating system).

The processor 224 may support content delivery. Various informational assets, e.g., information for presentation on the display 222 described above or usage data gathered from the consumer for communication to a remote server, may be stored locally (e.g., in the memory 226), such that the content is available in the absence of connectivity. In addition to software upgrades and the like, the dispenser 210 may periodically check for updates to the content, which can be downloaded and stored locally as new content is made available. In the same manner, usage data may be relayed back to a server in a periodic or event driven manner such that a user's consumption profile can be kept up to date. This same connectivity can relay purchases or orders for beverage cartridges 250, e.g., to a remote resource such as a store. Similarly, this connectivity may engage a user (e.g., through a social networking platform) with a plurality of users having similar dispensers 210, or have similar end-user experiences, similar consumption patterns, similar tastes and so forth, or with others within a preexisting social network for the user. Geographic proximity to other users may also or instead be used as a basis for establishing or suggesting communications among users. As such, the processor 224 may communicate with one or more location sensors (e.g., GPS) included on the dispenser 210 or a user device.

The dispenser 210 or another component in the system 200 may also include secondary processing devices including without limitations microcontrollers, co-processors, digital signal processors, and the like. For example, a secondary microcontroller may be used to gather sensor data, manage power, support signal processing functions, communicate such data to the processor 224, and so forth. In one aspect, the secondary microcontroller may be a lower power device relative to the processor 224 in order to advantageously offload maintenance tasks and lower level functions, such as power management, battery charging, temperature sensing, RFID readings, accelerometer readings, and so forth. The secondary microcontroller may also monitor an accelerometer or other sensor(s) or device(s) and “wake up” the processor 224 and other system components when activity is detected, e.g., when the dispenser 210 is touched or picked up. Thus, in one aspect, the dispenser 210 may usefully incorporate a low-power system independent of other control hardware and software that is configured to detect a user interaction and initialize or activate the control hardware at appropriate times. Alternatively, a single processor 224 may perform all functions of the system 200.

The memory 226 may include any volatile or non-volatile memory or other computer-readable medium suitable for storing information as contemplated herein, including without limitation a Random Access Memory (RAM), a flash memory, a Read Only Memory (ROM), a Programmable Read-only Memory (PROM), an Erasable PROM (EPROM), registers, and so forth. The memory 226 may store program instructions, program data, executables, and other software and data useful for controlling operation of a component in the system 200 and configuring the dispenser 210 to perform functions for a user. The memory 226 may include a number of different stages and types for different aspects of operation. For example, a processor 224 may include on-board memory and/or cache for faster access to certain data or instructions, and a separate, main memory or the like may be included to expand memory capacity as desired.

The memory 226 may, in general, include a non-volatile computer readable medium containing computer code that, when executed by a component of the system 200 creates an execution environment for a computer program in question, e.g., code that constitutes processor firmware, a protocol stack, a database management system, an operating system, or a combination of the foregoing, and that performs some or any steps or methods set forth herein.

The memory 226 may store beverage information 206 for a number of beverages 256 in a number of beverage cartridges 250. The beverage information 206 may include interactive content relating to the number of beverages 256 for presentation on the display 222 of the dispenser 210. The memory 226 may also or instead store a history of beverage distribution from the dispenser 210 for a number of beverage cartridges 250. The memory 226 may also or instead store data including without limitation user feedback, ratings, notes or the like, which may be retained for private use by the user or shared in a social networking platform. This data may also be used, e.g., with the user's permission, to provide recommendations of beverages with similar tastes, pricing, marketing information/offers, and so forth.

Although described as part of the dispenser 210, the processor 224 and memory 226 may also or instead be disposed on another component of the system 200 such as the beverage cartridge 250, a user device, or a remote resource.

The system 200 may include a network interface 228, e.g., coupled to one or more of the dispenser 210 and the beverage cartridge 250. The network interface 228 may be configured to couple the processor 224 in a communicating relationship with a remote resource (such as those described above with reference to FIG. 1). The network interface 228 may include a short range radio frequency communications interface, e.g., for Bluetooth or the like. The network interface 228 may be the same or similar to those described above with reference to FIG. 1.

The processor 224 may be configured to retrieve beverage information 206 for the beverage 256 from the remote resource and present the beverage information 206 on the display 222. The beverage information 206 may include interactive content such as a user-navigable guide to the wine, information regarding the vintner, a geographic or meteorological history, and so forth. This may be further linked to information about particular varieties of grapes, popular or critical wine rankings, price guides, and so forth. To this end, the processor 224 may be configured to present an interactive interface in the display 222 on the user interface 220.

The interactive interface in the display 222 may be configured for purchasing beverages through a remote resource. In an aspect, a remote resource is configured to monitor consumption behavior based on the distribution of beverages from the dispenser 210. The remote resource may present purchase recommendations on the display 222 based on inferred beverage preferences. In an aspect, the network interface 228 is configured to couple the processor 224 in a communicating relationship with the remote resource for at least one of (i) monitoring fluid consumption from the beverage container 250, (ii) recommending additional beverages for purchase, and (iii) performing a transaction to purchase a new beverage.

The system 200 may include a fluid sensing system 230. The fluid sensing system 230 may include one or more sensors 232 providing signals to the processor 224. The system 200 may include code executable by the processor 224 (e.g., disposed in the memory 226) to receive signals from the fluid sensing system 230 and to calculate or estimate an amount of fluid dispensed from the beverage cartridge 250. This information may be further used to track consumption patterns, estimate fluid remaining within the beverage cartridge 250 or for any other reasons. An input to the fluid sensing system 230 may include a current amount of fluid present in a beverage cartridge 250. The system 200 may also or instead include a fluid monitoring system 231. The fluid monitoring system 231 may include one or more sensors (e.g., the sensors 232 described above) disposed within the dispenser 210 that provide signals to the processor 224 (or other processing circuitry) for calculating an amount of fluid remaining within a beverage cartridge 250. It will be appreciated that the fluid monitoring system 231 and the fluid sensing system 230 may be the same system, or independent systems for capturing separate measurements of fluid flow exiting a container and an amount of fluid remaining in the container.

The processor 224 may be configured to transmit beverage dispensing information, e.g., to a remote resource based on the amount of fluid dispensed. The processor 224 may also or instead be configured to store the beverage dispensing information on the memory 226 for the dispenser 210, or to store the beverage dispensing information on a separate memory 252 included on the beverage cartridge 250. In this manner, if the beverage cartridge 250 is removed from the dispenser 210, the beverage cartridge 250 may retain the beverage dispensing information for future uses by other similarly configured dispensers. As described above, the beverage dispensing information may include an estimate of fluid remaining in the beverage cartridge 250.

The system 200 may include one or more other sensors 234 in addition to or in lieu of the sensors 232 included in the fluid sensing system 230. The sensors 234 may include one or more environmental sensors, where the processor 224 is configured to receive environmental data from the one or more environmental sensors and estimate a state of contents of the beverage cartridge 250 based on the environmental data. The one or more environmental sensors may include at least one of a temperature sensor, a pressure sensor, a humidity sensor, a contaminant sensor, a sensor for exposure to light, and so forth. The sensors 234 may be configured to provide specific environmental information related to a fluid in the beverage cartridge 250, e.g., a beverage for consumption. For instance, a temperature sensor can measure the temperature of the beverage cartridge 250, either directly or indirectly, e.g., using a contact or non-contact temperature sensing technique. This temperature (or other sensed property) can be compared to the ideal serving temperature of the beverage cartridge 250, and the dispenser 210 can alert the user as to whether or not the beverage is within its ideal serving temperature range. The dispenser 210 can also offer a suggested time to wait before the beverage is within the ideal serving temperature range.

The dispenser 210 or beverage cartridge 250 can also monitor temperature (or other properties) over time. A maximum temperature and/or an integrated temperature over time may provide useful indicators of potential spoilage. By logging temperature in the beverage cartridge 250, temperature history may be downloaded and processed by the dispenser 210 when the beverage cartridge 250 is inserted so that, e.g., a user can be alerted of potentially spoiled or unsafe contents. To this end, the beverage cartridge 250 may include a powered RFID tag or the like. A contactless IR temperature sensor may be used to simplify mechanical design and potentially increase the longevity of the system 200. For example, the sensor 234 may be located relatively low on the beverage cartridge 250 or in a floating device disposed in the fluid in the beverage cartridge 250 in order to measure a liquid temperature even when the liquid level is low.

The one or more other sensors 234 may also or instead include an accelerometer, gyroscope, weight sensor, an optical sensor, and so forth. The sensors 234 may be mounted in various locations of the dispenser 210. As such, a variety of other sensors or monitoring functions may also or instead be usefully incorporated into the dispenser 210. By way of non-limiting example, and as described above, the dispenser 210 may monitor contents of the beverage cartridge 250 either by direct sensing or by inference based on, e.g., how much has been dispensed. This may be used to display information on the display 222 relating to, e.g., the number of drinks left in a bottle, the volume of liquid remaining, or any other suitable information relating to the remaining contents. In another aspect, a sensor 234 may be used to track whether a beverage cartridge 250 has been used before, and if so, when it was first breached, how often it has been removed from and returned to the dispenser 210, and so forth. This information can be used to display useful shelf life remaining on the beverage 256 in the beverage cartridge 250. Other information such as temperature history (as discussed above) may be used to augment this calculation and more accurately predict useful shelf life. For certain beverages, such as unfiltered beverages with sediment or carbonated beverages that can be pressurized by physical agitation, it may be appropriate to determine how long the beverage cartridge 250 has remained still. An accelerometer or other suitable sensor 234 may thus be used to track motion of the beverage cartridge 250 or dispenser 210 and evaluate whether it might be inappropriate to access a beverage at a particular time.

The system 200 may include a valve control 236. The valve control 236 may include a manual valve control disposed on an exterior of the dispenser 210 and configured to control pouring from the beverage cartridge 250 based on a manual user input.

In one aspect, during pouring, the dispenser 210 may use flow rate, tilt angle, previous estimates of the remaining beverage in the beverage cartridge 250, or other information to estimate and update the amount of beverage remaining in the beverage cartridge 250 to present to the user. This may be accomplished, for example, using one or more of the fluid monitoring system 231 and the fluid sensing system 230, or instrumentation and components contained therein, e.g., sensors 232. The dispenser 210 may also actively manage measured pours, either in response to user positioning of the dispenser 210 or in response to the use of a particular button or other control (e.g., the valve control 236). For example, the valve control 236 may include a finger operated button (e.g. on the neck or other convenient location) that can be depressed to measure, e.g., a one ounce tasting pour or a five ounce full glass of wine. Similar buttons may also or instead be provided in the user interface 220 of the display 222. In another aspect, the dispenser 210 may automatically stop a pour with an actuated valve or other mechanism. The pour may, for example, stop after a standard wine glass pour, or the user may control the amount of fluid dispensed in a pour using, e.g., user preferences in the display 222. The dispenser 210 may also or instead provide a user notification such as an audio, a visual, or a tactile alert that a certain pour amount has been reached. In another aspect, the flow rate may be controlled. In another aspect, the user may manually control starting and stopping of the pour with a button, switch, or the like.

The processor 224 may be configured to determine a current user of the dispenser 210 during a pour. The current user may be determined based on a manual input in the user interface 220—for example, selection of a user's name on a button, a pattern drawn by the user, a code entered by the user, a fingerprint of the user, and so forth. The current user may also or instead be determined based on a pattern of motion detected during a pour from the dispenser 210. That is, a particular user may have characteristic movements while handling a bottle, including movement speed, movement pattern, pour rate, dwelling at particular locations or orientations, and so forth. This data may be used to create a kinematic fingerprint for a particular user so that the user can be identified based on detected movements during a particular bottle interaction. The current user may also or instead be determined based on recognition of a user device, e.g., when the user device is within a predetermined proximity to the dispenser 210, or based on facial recognition with the addition of a camera to the dispenser 210. In an aspect, the dispenser 210 may not permit a pour (or other functions of the dispenser 210 may not be permitted) when the current user has not been determined or the current user has not provided a predetermined input.

In an aspect, a personalized purchase recommendation may be generated for the current user and presented on the display 222 of the dispenser 210. The recommendation may be based on a variety of factors including locally determined and remote factors. For example, a recommendation may be based on express tastes explicitly provided by a user, implicit tastes determined based on consumption or purchasing patterns, a social network for a user, or explicit recommendations sent to the user by other users within a social network.

As discussed herein, the dispenser 210 may be in communication with a remote resource such as a backend server or the like. The remote resource may support delivery of any traditional content to the dispenser 210 and its display 222, as well as social networking content and the like. The network interface 228 of the dispenser 210 may also or instead support a data feed from the dispenser 210 to the remote resource in order to track user preferences, usage data, purchase orders, and so forth. The dispenser 210 may also or instead passively monitor the amount of fluid being dispensed using any suitable techniques such as accelerometer data and a pouring algorithm.

The dispenser 210 may be used to manually, automatically, or semi-automatically order replacement beverages based on a user's consumption history. Thus, the dispenser 210 may operate as a beverage management device that determines when a beverage cartridge 250 has been finished and proactively inquires whether the user would like to order another beverage cartridge 250, or initiates a renewal order based on preexisting user instructions or preferences. The user may also, either using the user interface 220 or separately in a web interface for a remote resource or the like, establish a collection of favorite beverage cartridges 250 that can be automatically re-ordered when nearing completion of the beverage cartridge 250.

From a content or data exchange/delivery perspective, the beverage cartridge 250 being inserted into the dispenser 210 may be identified, either via RFID or some other method, so that the corresponding label and corollary content can be displayed. As discussed above, the network interface 228 may include WiFi, Bluetooth, cellular, WiMax, or the like in order to deliver data to a remote resource (e.g., remote server) and receive data from same. For example, the dispenser 210 may deliver purchase requests and consumption data, which may be delivered at any level of granularity. For example, consumption data may track when a beverage cartridge 250 is emptied or replaced, when a drink is dispensed, how much liquid was dispensed, and so forth. At the same time, the dispenser 210 may receive content, such as detailed information about a particular wine—e.g., geography, aging, history, grapes, alcohol content, weather information for the winery or other conditions that might affect wine flavor, serving suggestions (temperature, breathing, and so on), reviews, social network content, commercial content from a vintner, and so forth. The dispenser 210 may also store local information relevant to wine consumption such as current wine temperature, air temperature, amount of beverage remaining, time since the beverage cartridge 250 was first breached, and so forth. Any or all of this information may be presented in the display 222, which, as discussed above, may include a touch screen or other user interface control so that a user of the dispenser 210 can navigate to relevant information, make purchases, provide feedback or ratings, and so forth.

In one aspect, the beverage information 206 may provide or enhance a ‘story’ behind the contents being dispensed (e.g., wine, craft beer, and so forth). Thus, a ‘smart label’ may be provided on the display 222 of the dispenser 210 for displaying such information. The dispenser 210 may download the information from a remote resource or read information from a beverage cartridge 250, and present this information in a multi-page or multimedia presentation which may include interactive content delivered, e.g., through a touch screen or the like in which a user can navigate within the user interface 220 supported by the smart label to learn the story behind a wine. This may include video, audio, text, databases, hypermedia and so forth. Other information generally or specifically related to liquid contents may also or instead be provided. This may include without limitation recommended food pairings, recipes, serving suggestions, similar beverages, and so forth.

Similarly, some beverages are better consumed if decanted for a period of time after being dispensed. In this case, the dispenser 210 may alert the user with information on how long the beverage should be decanted. Other information and recommendations such as a glass type or style, a serving temperature, or any other aspects of presentation or consumption may also or instead be provided.

The dispenser 210 may be powered by a battery or any other suitable electrical energy storage device or system. There are several options for charging a battery, including contact and non-contact solutions. For example, inductive charging may be employed using any suitable wireless coupling technique for short range transmission of power. In another aspect, the dispenser 210 may include a Universal Serial Bus (USB) plug for coupling to a USB cable or docking station, which may provide power to the battery through a local charging circuit or the like. In another aspect, a proprietary contact coupling may be provided in a docking station, which may be coupled to an external power source for directly charging the battery or for powering a local charging circuit on the dispenser 210, e.g., via a docking station coupling/interface. More generally, any other standardized or proprietary coupling configuration may also or instead be employed to charge the battery as desired.

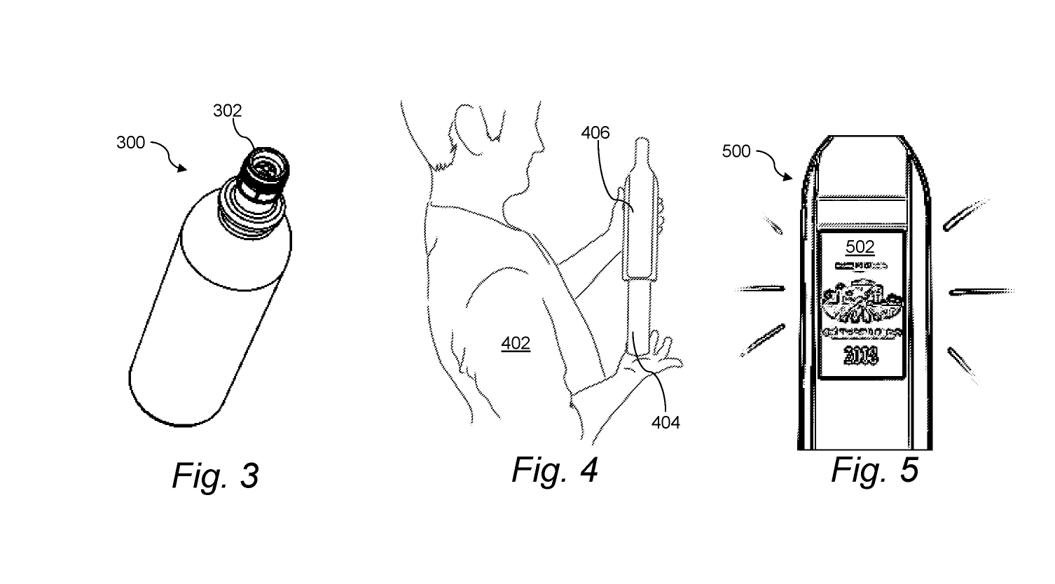

FIG. 3 shows a cartridge. The cartridge 300 may be configured for insertion and engagement with a dispenser. To this end, the cartridge 300 may include an interface 302 structurally configured for engagement with a dispenser.

FIG. 4 shows a cartridge being inserted into a dispenser. As shown in the figure, a user 402 may insert the cartridge 404 into the dispenser 406 from a bottom end of the dispenser 406. Specifically, the cartridge 404 containing the beverage to be dispensed may be inserted into the dispenser 406 from a bottom end where it ‘clicks’ into the dispenser 406 or otherwise forms a secure mechanical engagement. The engagement may also or instead be facilitated through screwing the cartridge 404 into the dispenser 406, or otherwise. Similarly, configurations other than a bottom end insertion are also or instead possible as will be appreciated by a person having ordinary skill in the art. Proper insertion of the cartridge 404 into the dispenser 406 may actuate a valve included in the cartridge 404 thereby allowing contents to be poured from within the cartridge 404 through a spout of the dispenser 406.

The cartridge 404 may be removably and replaceably coupled to the dispenser 406, which can facilitate modular, sequential use of multiple cartridges with different fluids contained therein. When engaged, the dispenser 406 may enclose a majority of the cartridge 404, e.g., so that the ornamental appearance of a wine bottle or other carrier is maintained. In an aspect, the dispenser 406 includes a control to manually eject a cartridge 404. The control may also or instead be used to open and close a valve of the system (or a separate control may be used for manually controlling the valve or performing other functions). The control may include a push button or the like, such as the valve control discussed above.

FIG. 5 shows a display on a dispenser. As shown in the figure, the dispenser 500 may be shaped to resemble a wine bottle, and the display 502 may be configured to be an electronic or ‘digital’ wine label integral with the dispenser 500. In an aspect, once the cartridge is inserted into the dispenser 500, a data reader or the like recognizes the cartridge and displays its label (or other information related thereto) on the display 502.

The cartridge and the dispenser 500 may be advantageously configured for an alignment-independent communications interface that can operate independently of the rotational alignment of a cartridge inside the dispenser 500. The cartridge may also or instead be mechanically keyed to enforce a specific rotational alignment during insertion. Proper insertion of the cartridge into the dispenser 500 can be ensured through feedback, e.g., mechanical (a ‘click’ or the like) or otherwise.

The dispenser 500 may actively or passively open the cartridge in a variety of manners. For example, the dispenser 500 may passively open the cartridge when the cartridge is inserted into the dispenser 500, and keep the cartridge open until it is removed, or the dispenser 500 may provide a manual opening/closing mechanism to open and close the cartridge. In another aspect, the dispenser 500 may actively (e.g., with sensors and actuators) or passively (e.g. through a non-powered switch or other mechanism) open and close in response to pouring motions, e.g., when the dispenser 500 is tipped or when pressure is exerted on a valve or the like. This permits the dispenser 500 to pour naturally when tilted while also sealing the beverage contents within the cartridge during non-use to limit oxygen exposure and preserve shelf-life. In one aspect, the dispenser 500 may mimic the natural pouring behavior of an opened bottle or beverage container, so that no additional or unnatural motions or actions are required from a user other than tipping the dispenser 500 to pour, or possibly tipping the dispenser 500 in combination with activating a button or other control. In another aspect, the dispenser 500 may include a spill-proof mechanism. This may, for example, be a passive mechanical system that seals automatically when the dispenser 500 rapidly changes position, or this may be an electro-mechanical system using inertial sensors or the like to detect motion that is associated with accidental tipping or the like, and to actively seal the cartridge during suspected accidents.

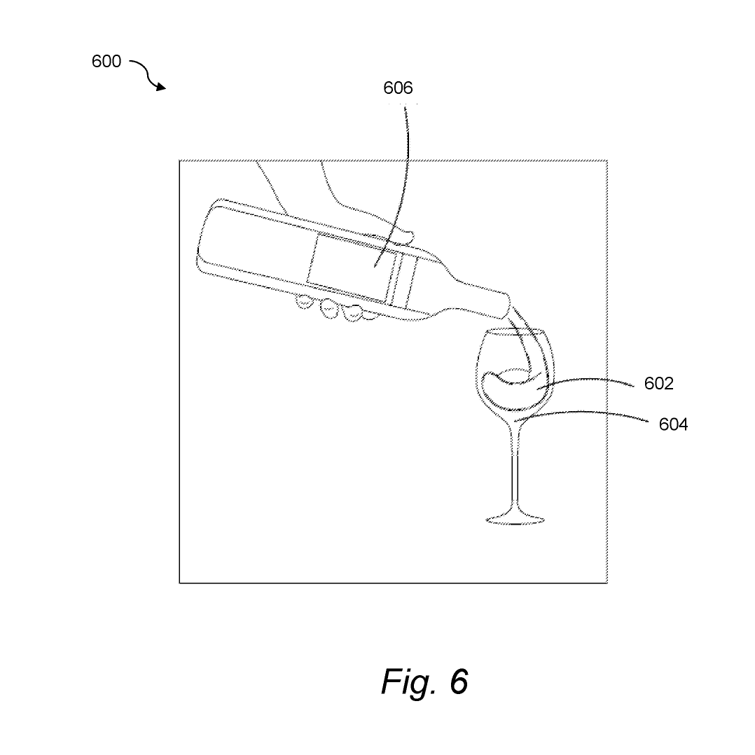

FIG. 6 shows a beverage system in use. The beverage system 600 may include a cartridge engaged with a dispenser as described herein. As shown in the figure, the beverage system 600 may be tilted at or above a predetermined tilt angle to allow for pouring of wine 602 into a glass 604. As noted above, the dispenser may include sensors, a network interface (e.g., for WiFi, Bluetooth or other short range wireless communications) or other systems to recognize a wine or the like contained in a cartridge, and the display 606 may show a label corresponding to the detected contents of the cartridge. The dispenser may also or instead display other pertinent information. The dispenser may also be configured to detect other environment conditions and display relevant information. For example, the dispenser may sense and display a recommended drinking temperature for the beverage contents, along with a current measured temperature of the beverage contents. Where appropriate, the dispenser may also estimate an amount of time for the contents to reach the recommended temperature and display this information in the display 606. In another aspect, the dispenser may be configured to meter a pour from the dispenser. The dispenser may, for example, measure and control an amount of fluid that is poured, and the user interface may provide a control that permits a user to select from free pouring and measured pours of various amounts (e.g., 1 to 2 oz. for a wine tasting, or 5 oz. for a full glass of wine.

In another aspect, the beverage system 600 may estimate how much fluid is remaining in a cartridge, particularly where the dispenser or beverage cartridge is opaque and thus precludes visual inspection. To perform this estimation, the flow rate of the beverage out of the beverage system can be estimated based upon the remaining beverage and the tilt angle of the beverage system using any suitable physical or empirical model for a particular valve configuration. These flow rates may be integrated over time during pours to predict how much beverage has been poured out during a single pour. This amount may then be subtracted from the known total remaining in the beverage system. In one aspect, the beverage cartridges can be assumed to start completely full and further assumed to be only used with a specific dispenser so that the beverage system can independently estimate usage. In another aspect, the amount of beverage can be stored on an RFID tag on the cartridge, and updated in any suitable manner such as after each pour or whenever the cartridge is removed from the dispenser. Other techniques may also or instead be employed. For example, one or more sensors may be configured to measure a mass of the cartridge, so that changes in the mass can be detected and used to calculate fluid dispensed and fluid remaining.

A particular technique for measuring tilt angle and estimating pour amounts is now discussed in greater detail.

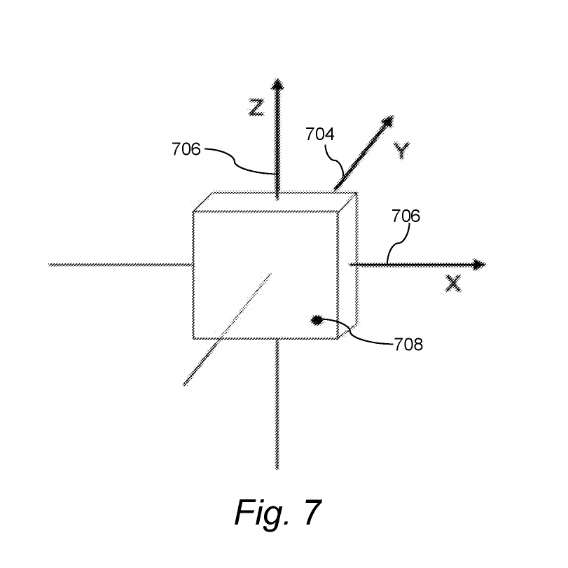

FIG. 7 shows a coordinate system for measuring dispenser acceleration. Specifically, the figure shows an x-axis 702, a y-axis 704, and a z-axis 706, and the acceleration along each of these axes 702, 704, 706 may be independently measured and used to estimate pouring behavior as contemplated herein.

More specifically, acceleration data along each of the x-axis 702, y-axis 704, and z-axis 706 may be read from an on-board accelerometer included on one or more of the dispenser or the cartridge. Using this acceleration data, and knowing the orientation of the axes relative to the dispenser, the pitch 708 (tilt angle from the z-axis 706) of the dispenser can be calculated and plotted using the equation below:

$$Pitch = α = \frac{y}{\sqrt{{x}^{2} + {z}^{2}}}$$

This equation may be dependent on accelerometer orientation in the beverage system, and can change based on this orientation. As such, in an aspect, the accelerometer may remain fixed relative to the coordinate system of the dispenser.

The x, y, and z signals from the accelerometer may be monitored by a microprocessor (or other processing circuitry) and the pitch calculation may be performed based on the sensed signals. This data may be used in combination with a pouring model to estimate fluid flow and remaining beverage. In general a useful model for this estimate can be created that characterizes pouring from the dispenser as a function of tilt angle (pitch) and remaining beverage. With this information and current pitch information, the current pour rate (or pour volume) may be calculated and used for other control functions such as estimating remaining beverage or determining when to stop a current pour.

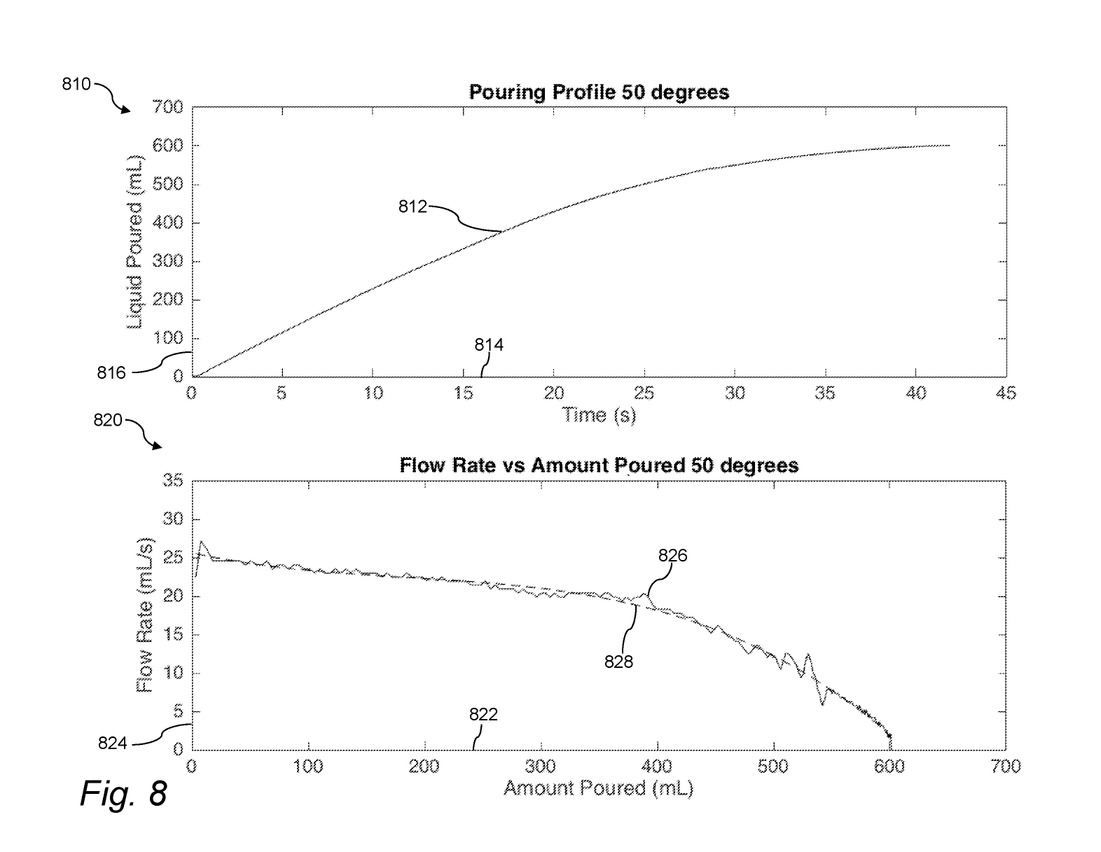

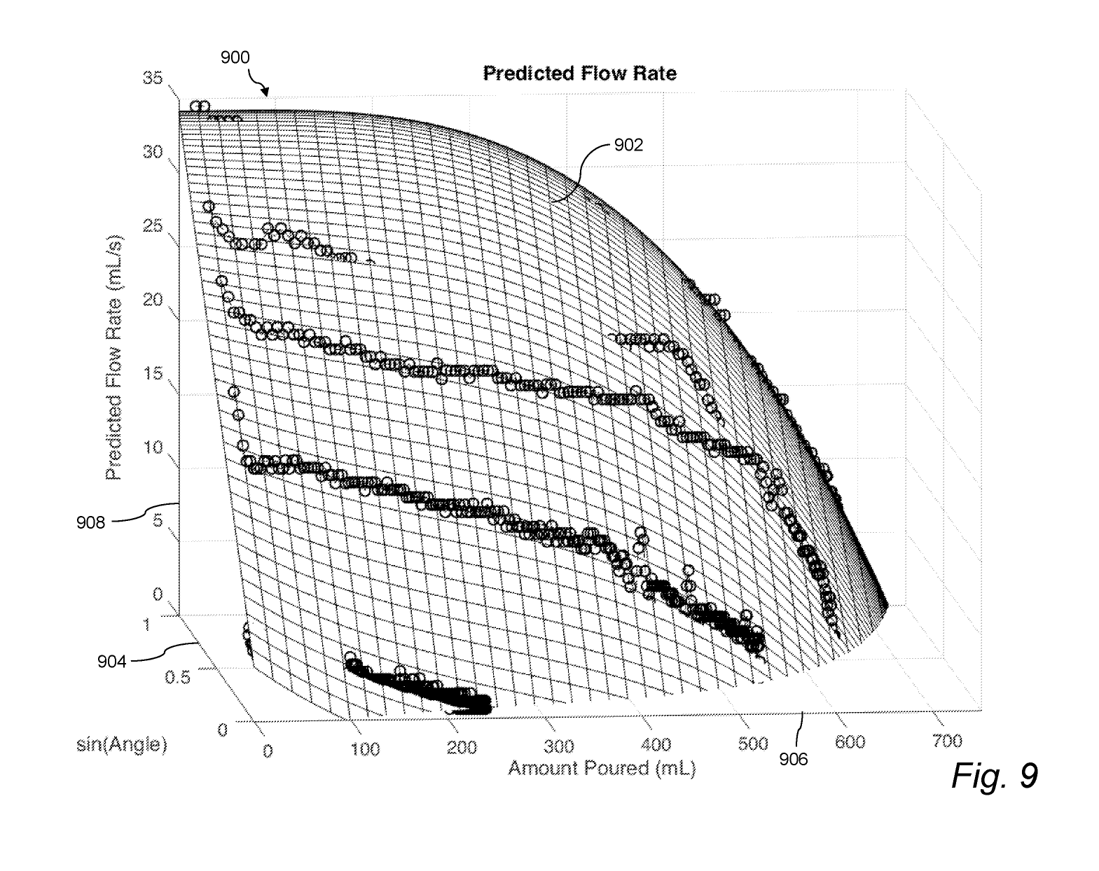

FIG. 8 shows a first graph representing a pouring profile for a negative 50 degree tilt angle from horizontal of a container and a second graph representing flow rate versus an amount poured from the container. As used throughout, the container may be the dispenser and/or the cartridge as described herein.

The first graph 810 represents the ‘pouring profile,’ which may be a characterization of the amount of beverage being poured out of a cartridge through a dispenser at a given fixed angle for a cartridge of liquid. In the example shown in the first graph 810, the pouring profile 812 is shown for a tilt angle of negative 50 degrees, i.e., 50 degrees past a horizontal position. In first graph 810, the x-axis 814 represents time in seconds (s), and the y-axis 816 represents the liquid poured in milliliters (mL).

The derivative of the line representing the pouring profile 812 is the flow rate of the beverage being poured out of the dispenser in milliliters per second (mL/s). The numeric derivative of this data can be found using known means, yielding a curve depicting the flow rate (mL/s) at a given angle. It may instead be more useful to plot the flow rate versus the amount poured out of the container, as described below, which enables a relation of flow rate to angle and amount poured.

The second graph 810 represents the flow rate versus an amount poured from the container at a tilt angle of negative 50 degrees, i.e., 50 degrees past a horizontal position. In the second graph 820, the x-axis 822 represents the amount poured in milliliters (mL) and the y-axis 824 represents flow rate in milliliters per second (mL/s) of a container. The first line 826 (the solid line in the figure) shows the relationship between the flow rate of a container system versus an amount poured at a 50 degree tilt angle, and the second line 828 (the dashed line in the figure) represents a best fit.

Several pouring profiles at different fixed angles can be constructed. A regression analysis can then be performed to find the best fit equation describing the relationship between flow rate and residual liquid at a fixed angle. The regression may provide the coefficients of a polynomial that fits the flow rate versus the amount poured (the second line 828 shown in the second graph 810). Using these coefficients, the flow rate at a fixed angle can be solved for with relative computational ease using one of several methods given the amount that is poured.

For example, the flow rate can be calculated for several different angles using a polynomial solving function that takes the coefficients of the polynomial described above and the current amount poured out as inputs. Using techniques described above, pouring profiles depicting flow rate versus an amount poured at several different angles can be characterized. It may be useful to use data across a full spectrum of angles for which liquid will pour, for example, from negative 4 degrees to positive 90 degrees (angles from horizontal).

Using data from several discrete angles, an interpolation method can be used to solve for the flow rate at interstitial angles for which there is no polynomial. For instance, if there are polynomials to describe the pouring profile of 30 degrees and 40 degrees, and the current angle is 35 degrees, the flow rate can be predicted by linear interpolation between predicted flow rates at 30 and 40 degrees. That is, the flow rates at both 30 and 40 degrees at the amount poured may both be solved for, and then weighted accordingly to predict the flow rate for 35 degrees. Pseudo-code implementing this method is set out below:

```
          %p is proportional factor for weighting flow rates
          p = (sin(angle) − sin(LowAngle))/(sin(HighAngle) −
sin(LowAngle));
          FR_angle = FRlow*(1−p) + FRhigh*p;
```

FIG. 9 shows a graph of a three-dimensional surface used to predict flow rate at a given angle and history of amount poured. This three-dimensional surface provides supports a related analytical technique for estimated flow rate. For this surface, the flow rate may be the dependent variable, where the amount poured and the angle are the independent variables. As shown on the graph 900, using data from a full spectrum of angles for which liquid will pour, a three-dimensional surface 902 can be plotted that predicts flow rate at a given angle, and possibly more advantageously, a polynomial equation that describes the three-dimensional surface 902 can be found. Using this polynomial equation, the flow rate may be solved for using a polynomial solving function with the amount poured and angle as inputs. As shown on the graph 900, the angle of pour (or more specifically, the sine of the angle of pour) may be plotted on a first axis 904, the amount poured may be plotted on a second axis 906, and the predicted flow rate may be plotted on a third axis 908.

A fit equation can describe the three-dimensional surface 902, and flow rate may be predicted from angle and amount poured as inputs:

```
      FR = p00 + p10*vol + p01*sin(angle) + p20*vol 2+
p11*vol*sin(angle) + p30*vol 3 + p21*vol 2*sin(angle);
      %FR is flow rate
      %vol is volume poured
      %angle is current angle
```

For more complex surfaces that are not amenable to accurate, low-order polynomial representation, a lookup table based on the three-dimensional surface may also or instead be used.

Temperature correction to flow rate will now be discussed.

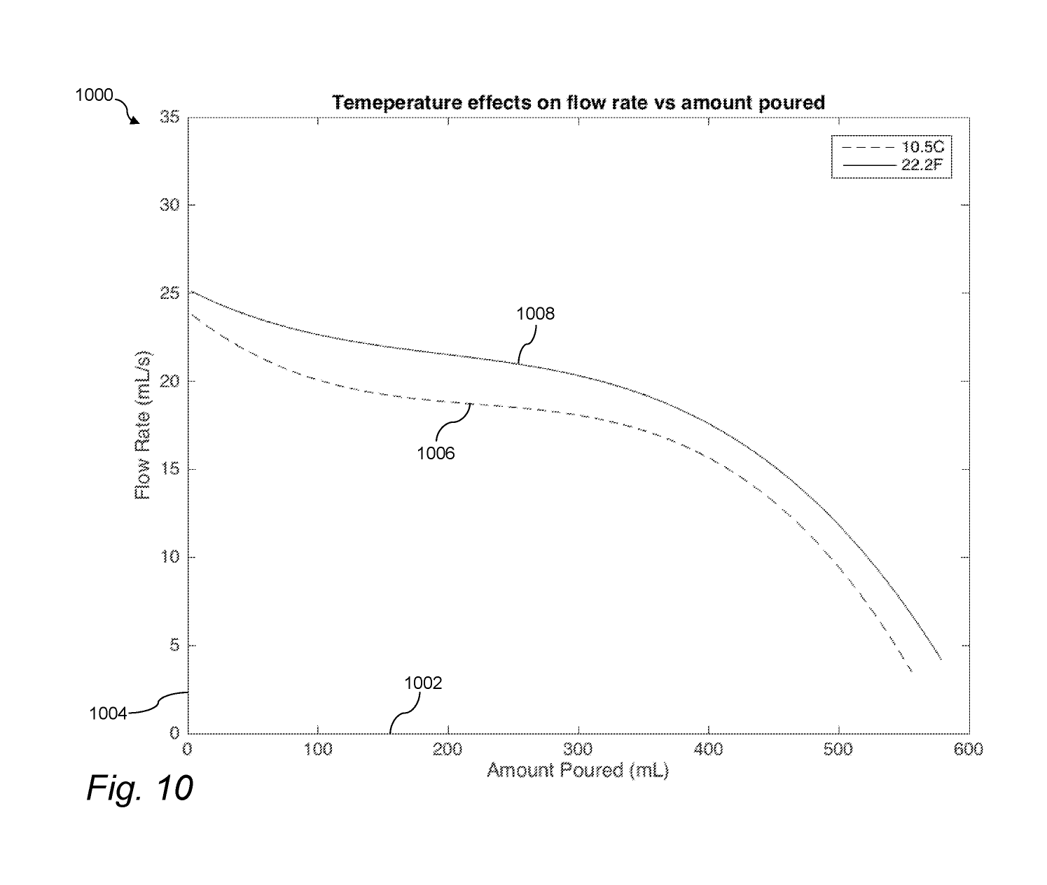

FIG. 10 shows a graph representing the effect of temperature on flow rate. The graph 1000 shows an x-axis 1002 that represents the amount poured in milliliters (mL) and a y-axis 1004 that represents the flow rate in milliliters per second (mL/s) of a container. The first line 1006 (shown as a dashed line in the figure) represents pouring at 10.5 degrees Celsius and the second line 1008 (shown as a solid line in the figure) represents pouring at 22.2 degrees Celsius.

According to Poiseuille's equation, flow rate (FR) is proportional to 1/viscosity (η):

$$FR \sim \frac{1}{η} dP * [ geometry ]$$

This is experimentally shown by the graph 1000 in the figure.

In order to correct for the temperature effect on flow rate, the predicted flow rate solved for by one of the methods described above may be multiplied by a temperature correction factor that is proportional to the measured temperature of the beverage.

Computing an amount poured will now be discussed.

Using an iterative approach, an estimate of the beverage remaining can be computed in real time using an integrator. For example, if a container starts full (with zero mL poured out), and it is tilted to 20 degrees, the flow rate can be calculated by the techniques described above. If it is assumed that a container is held at this angle for a discrete period of time (e.g., 0.01 seconds), a microcontroller or other component/computing device may multiply the calculated flow rate in that interval by a discrete period of time (e.g., 0.01 seconds) to compute how much liquid has been poured out of the container. The microcontroller may then measure the tilt again, and solve for a new flow rate using the updated tilt angle and updated amount of liquid remaining, and again multiply by the discrete period of time over which the calculated flow rate is considered valid. This approach may be repeated over the life of a cartridge to attain a reasonable, passive approximation of how much liquid is remaining in the cartridge. Where the dispenser includes a manual pour control or an automated switch for spill prevention, pour measuring or the like, this information may also be used as an input to the integration so that the flow rate is only integrated while the dispenser is in a state for pouring.

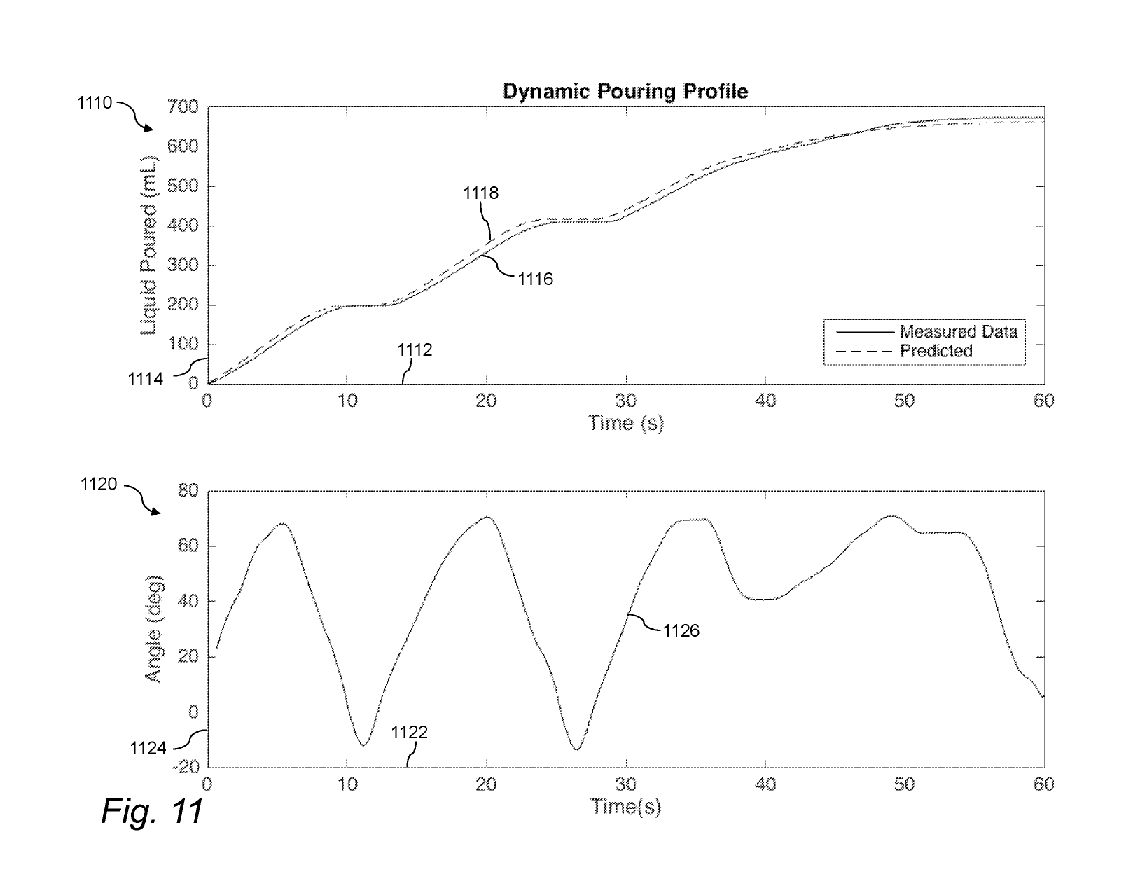

FIG. 11 shows a first graph representing an amount of liquid poured over time and a second graph representing a tilt angle over time. Specifically, the figure shows a first graph 1110 having a y-axis 1114 representing liquid poured in milliliters (mL) over time, which is shown on the x-axis 1112. The first graph 1110 includes a first plotted line 1116 of measured data (shown as a solid line in the figure) and a second plotted line 1118 of predicted data (shown as a dashed line in the figure), where the plotted lines may be relatively close using the techniques discussed herein. The figure also shows a second graph 1120 having a y-axis 1124 representing the tilt angle in degrees (deg) over time, which is shown on the x-axis 1122, and a plot 1126 for a pour. The figure represents a predictive estimator using the techniques discussed herein.

The latest estimated amount of beverage left in a cartridge may be recorded at the end of a pour to be used as the starting point for the next set of calculations, and also to give a real time indicator of how much beverage is remaining in the cartridge inside a dispenser.

It will be appreciated that the above mathematical derivations and other graphical depictions are provided by way of example only. Depending on the shape of the container, properties of any internal flexible container or sealing container, and the shape and mechanics of any valves included therein, as well as numerous other factors, the actual behavior may vary significantly. Other techniques may also or instead be used to measure the remaining liquid including without limitation optical analysis of the interior of the cartridge or fluids therein, weight of the cartridge (which may be measured, e.g., using a suitable arrangement of pressure sensors, piezoelectric elements, or the like), and so forth.

The above systems, devices, methods, kits, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the systems and methods described above may be embodied in any suitable transmission or propagation medium carrying computer-executable code and/or any inputs or outputs from same.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It should further be appreciated that the methods above are provided by way of example. Absent an explicit indication to the contrary, the disclosed steps may be modified, supplemented, omitted, and/or re-ordered without departing from the scope of this disclosure.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A system for beverage dispensing comprising:
a dispenser shaped and sized as a wine bottle, the dispenser including a spout and a receptacle, the receptacle configured to removably and replaceably retain a beverage cartridge in an active engagement providing a fluid path to pour a fluid from the beverage cartridge through the spout;
a cartridge interface disposed within the dispenser and configured to receive and mechanically retain the beverage cartridge in the active engagement with the dispenser, the cartridge interface further including a data reader configured to read information from the beverage cartridge about a beverage in the beverage cartridge;
a user interface including a display disposed on an exterior of the dispenser; and
a processor within the dispenser, the processor configured to receive information about the beverage from the data reader and to present corresponding information in the display.

2. The system of claim 1 further comprising a network interface coupled to the dispenser, the network interface configured to couple the processor in a communicating relationship with a remote resource.

3. The system of claim 2 wherein the processor is configured to retrieve beverage information for the beverage from the remote resource and present the beverage information on the display.

4. The system of claim 3 wherein the beverage information includes interactive content.

5. The system of claim 2 further comprising a fluid sensing system including one or more sensors providing signals to the processor and code executable by the processor to detect an amount of fluid dispensed from the beverage cartridge.

6. The system of claim 5 wherein the processor is configured to transmit beverage dispensing information to the remote resource based on the amount of fluid dispensed.

7. The system of claim 5 wherein the beverage dispensing information includes an estimate of fluid remaining in the beverage cartridge.

8. The system of claim 5 wherein the processor is configured to store the beverage dispensing information on a memory of the beverage cartridge.

9. The system of claim 2 wherein the network interface includes a short range radio frequency communications interface.

10. The system of claim 2 wherein the processor is configured to present an interactive interface in the display for purchasing beverages through the remote resource.

11. The system of claim 2 wherein the remote resource is configured to monitor consumption behavior based on distribution of beverages from the dispenser and to present purchase recommendations on the display based on inferred beverage preferences.

12. The system of claim 1 wherein the data reader includes a radio frequency identification tag reader positioned to read a corresponding radio frequency identification tag positioned on the beverage cartridge.

13. The system of claim 1 further comprising one or more environmental sensors, wherein the processor is configured to receive environmental data from the one or more environmental sensors and estimate a state of contents of the beverage cartridge based on the environmental data.

14. The system of claim 13 wherein the one or more environmental sensors include at least one temperature sensor.

15. The system of claim 1 further comprising a manual valve control disposed on an exterior of the dispenser and configured to control pouring from the beverage cartridge based on a manual user input.

16. The system of claim 1 further comprising a memory within the dispenser, the memory storing beverage information for a number of beverages in a number of beverage cartridges, the beverage information including interactive content relating to the number of beverages for presentation on the display of the dispenser.

17. The system of claim 16 further comprising a memory within the dispenser, the memory storing a history of beverage distribution from the dispenser for a number of beverage cartridges.

18. The system of claim 1 wherein the processor is configured to determine a current user of the dispenser during a pour.

19. The system of claim 18 wherein the current user is determined based on a manual input in the user interface or a pattern of motion detected during a pour from the dispenser.

20. The system of claim 19 wherein a personalized purchase recommendation is generated for the current user and presented on the display.

21. A system for beverage dispensing comprising:
a dispenser shaped for attachment to a beverage container;
a mechanical interface for coupling the dispenser to the beverage container;
a data reader configured to capture data from the beverage container attached to the dispenser;
a user interface including a display disposed on an exterior of the dispenser; and
a processor within the dispenser, the processor configured to receive information about the beverage from the data reader and to present corresponding information in the display.

22. The system of claim 21 further comprising a fluid monitoring system including one or more sensors disposed within the dispenser and configured by the processor to monitor fluid information including at least one of fluid exiting the beverage container and fluid within the beverage container.

23. The system of claim 21 further comprising a network interface, the network interface configured to couple the processor in a communicating relationship with a remote resource for at least one of monitoring fluid consumption from the beverage container, recommending additional beverages for purchase, and performing a transaction to purchase a new beverage.

24. A system for beverage dispensing comprising:
a dispenser including a spout and a receptacle, the receptacle configured to removably and replaceably retain a beverage cartridge in an active engagement providing a fluid path to pour a fluid from the beverage cartridge through the spout;
a cartridge interface disposed within the dispenser and configured to receive and mechanically retain the beverage cartridge in the active engagement with the dispenser, the cartridge interface further including a data reader configured to read information from the beverage cartridge about a beverage in the beverage cartridge;
a processor within the dispenser, the processor configured to receive information about the beverage from the data reader; and
a network interface configured to couple the processor in a communicating relationship with a remote resource for at least one of monitoring fluid consumption from the beverage cartridge, recommending an additional beverage for purchase, and performing a transaction to purchase a new beverage.
